(19) United States
(12) Patent Application Publication
(10) Pub. No.: US 2018/0361177 A1
(43) Pub. Date: Dec. 20, 2018

(54) EXPANDABLE BATON STRUCTURE WITH HIDDEN SMASHER AT REAR END OF HANDLE AND HIDDEN SMASHER THEREOF

(71) Applicant: YUAN-TE LEE, New Taipei City (TW)

(72) Inventor: YUAN-TE LEE, New Taipei City (TW)

(21) Appl. No.: 15/670,184

(22) Filed: Aug. 7, 2017

(30) Foreign Application Priority Data
Jun. 14, 2017 (TW) 106208592

(51) Int. Cl. A62B 3/00

(52) U.S. Cl. CPC A62B 3/005; A62B 99/00

(57) ABSTRACT

An expandable baton structure with a hidden smasher at the rear end of a handle includes an outer tube and at least one inner tube in addition to the hidden smasher. The inner tube can be stored in the outer tube to form a short-stick configuration. The front end of the inner tube can also extend completely out of the outer tube to form a long-stick configuration. The hidden smasher is mounted at the rear end of the handle formed by the outer tube. While the hidden smasher is not in use, its smashing cone is stored in a protective cover. To use the hidden smasher, the protective cover is pressed against the surface of a to-be-smashed object and pushed for a predetermined distance in order for the smashing cone to extend out of a through hole in the protective cover and thereby smash the to-be-smashed object.

### FIELD OF THE INVENTION

The present invention relates to a baton structure and more particularly to a baton with a smasher at its tail end, wherein the smasher has a smashing cone hidden in the smasher while the smasher is not in use.

### BACKGROUND OF THE INVENTION

Tempered glass cannot be rapidly smashed without a proper tool, so doors and windows (including car windows) made of tempered glass tend to hinder escape from a house, car, or other glass-enclosed environment where an accident (e.g., a fire or car crash) takes place. In addition, the sharp broken pieces of such tempered-glass obstacles are hard to remove and may therefore delay escape or rescue or even lead to tragic consequences.

A glass material of high structural strength such as tempered glass and safety glass is so difficult to smash that a rescue team member striking it with a hammer, bat, or other heavy object may be injured by the massive recoil of the striking tool in use. To break such a robust glass material effectively, the only way is to hit the material perpendicularly and vigorously with a pointed heavy object. Currently, referring to FIG. 1, the market is supplied with a tool 11 (e.g., a baton or flashlight) for use by the police and fire departments to smash glass obstacles, wherein the tool 11 is mounted with a conical smasher 10. When a police officer or firefighter carrying out a raid or rescue operation encounters an obstacle 12 made of strong glass, he or she can take out the tool 11 immediately and hit the glass obstacle 12 with the smasher 10 in order to reduce the cohesive force within the glass obstacle 12, thereby forming a breaking point in, and consequently shattering, the glass obstacle 12 to facilitate attack or rescue.

In terms of use, however, the tool 11 leaves plenty of room for improvement. One major drawback, referring again to FIG. 1, consists in the fact that the smasher 10 is typically fixed at either end of the tool 11 in order to make the tool 11 portable, and that therefore one who uses the tool 11 must hold the tool 11 with the thumb facing themselves (as shown in FIG. 1) in order to apply a force to the smasher 10 and hit the glass obstacle 12 repeatedly. Nevertheless, the way the tool 11 is held makes it difficult not only for the user to exert a force on the smasher 10, but also for the user to strike precisely the same spot on the glass obstacle 12 while moving the smasher 10 back and forth. As a result, the cohesive force within the glass obstacle 12 may stay intact even though the user has made great physical efforts, and failure to smash the glass obstacle 12 in time may bring about failure of the intended attack or rescue. In addition, while the smasher 10 is carried around, the exposed conical portion of the smasher 10 may cause damage to the carrier's clothes or neighboring objects. Even worse, the conical portion may cause puncture injury to one who grabs the smasher 10 in a hurry. Hence, the issue to be addressed by the present inventio is to design a novel expandable baton structure that can solve the foregoing problems effectively.

### BRIEF SUMMARY OF THE INVENTION

In consideration of the inconveniences of the smasher on a conventional baton, the inventor of the present invention incorporated years of practical experience in research and development into an extensive research and repeated tests on batons and smashers and finally succeeded in developing an expandable baton structure with a hidden smasher at the rear end of the baton handle and the hidden smasher itself, with a view to overcoming the drawbacks of the prior art.

It is an objective of the present invention to provide a hidden smasher to be mounted at the rear end of a handle, or more particularly at the rear end of the handle of an expandable baton structure. The hidden smasher is composed of a base, a smashing portion, a protective cover, a restoring spring, and an engaging member. The base is provided therein with an aligning portion. The smashing portion is located in the base. The protective cover has a rear end formed with a through hole and a front end mounted at the rear end of the base. The protective cover can be axially displaced with respect to the base. The restoring spring is located between the base and the protective cover. When the rear end of the protective cover is not pressed, the restoring spring pushes the protective cover away from the smashing portion such that the smashing cone of the smashing portion is not exposed from the protective cover. When the rear end of the protective cover is pressed against the surface of a to-be-smashed object and then displaced toward the front end of the hidden smasher, the smashing rod of the smashing portion is pushed either directly or indirectly by the to-be-smashed object and consequently displaced in the base toward the front end of the base for a predetermined distance. Once the smashing rod is aligned by the aligning portion, the elastic energy stored in the compression spring in the smashing portion pushes the smashing rod either directly or indirectly and forces the smashing rod to strike toward the through hole of the protective cover, in order for the smashing cone on the smashing rod to smash the to-be-smashed object forcibly. The engaging member is mounted at the front end of the base so that, when the expandable baton structure is in a short-stick configuration, the engaging member can secure the rear end of an inner tube, allowing the expandable baton structure to stay firmly in the short-stick configuration.

Another objective of the present invention is to provide an expandable baton structure having a hidden smasher at the rear end of its handle. The expandable baton structure includes an outer tube and at least one inner tube in addition to the hidden smasher. The outer diameter of the front end of the inner tube is smaller than the inner diameter of the rear end of the outer tube so that the inner tube can be mounted into the outer tube through the rear end of the outer tube. Also, the configuration of the rear end of the inner tube matches the configuration of a portion of the outer tube that is adjacent to the front end of the outer tube so that, when the inner tube is displaced outward toward the front end of the outer tube and brings the rear end of the inner tube to a position in the outer tube that is adjacent to the front end of the outer tube, the outer wall of the rear end of the inner tube can engage with an inner wall portion of the outer tube that is adjacent to the front end of the outer tube, thereby allowing a portion of the inner tube that is adjacent to the rear end of the inner tube to be secured in the outer tube while the remaining portion of the inner tube is exposed from the front end of the outer tube. The hidden smasher has the same structure as described in the previous paragraph, with the base configured to be mounted to the outer tube, and the engaging member configured to extend into the outer tube so that, once the inner tube is stored in the outer tube, the engaging member can secure the inner tube and thus keep the expandable baton structure in a short-stick configuration.

### BRIEF DESCRIPTION OF THE SEVERAL VIEWS OF THE DRAWINGS

The objectives, technical features, and effects of the present invention can be better understood by referring to the following detailed description of some illustrative embodiments in conjunction with the accompanying drawings, in which:

FIG. 1 schematically shows a conventional baton with a smasher;

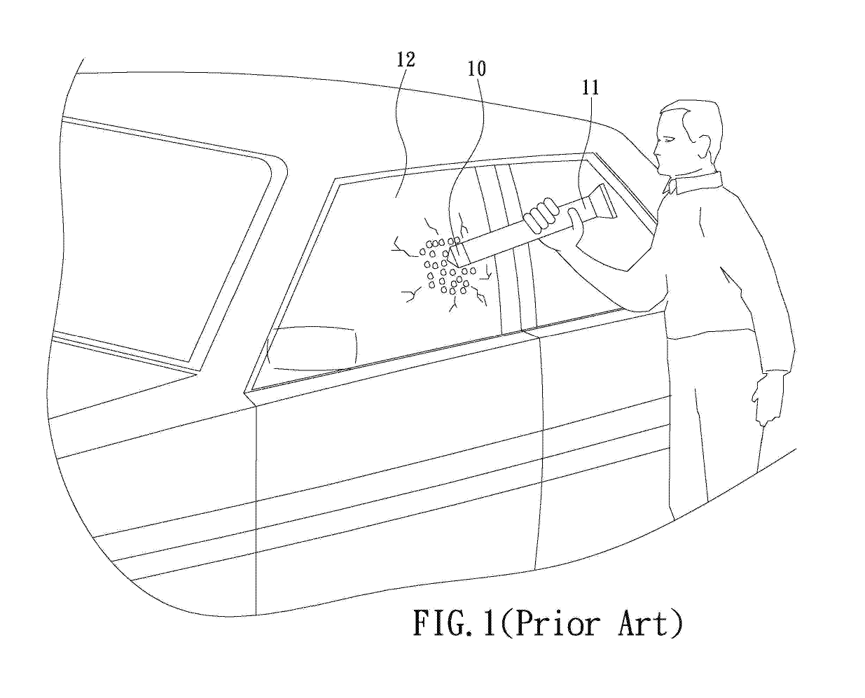

FIG. 2A shows the expandable baton structure of the present invention in a retracted state;

FIG. 2B shows the expandable baton structure in FIG. 2A in an expanded state;

FIG. 3 is a sectional view of the hidden smasher in the first embodiment of the present invention;

FIG. 4A is a sectional view of the hidden smasher in the second embodiment of the present invention;

FIG. 4B shows the hidden smasher in FIG. 4A in a different state; and

FIG. 5 is a sectional view of the hidden smasher in the third embodiment of the present invention.

### DETAILED DESCRIPTION OF THE INVENTION

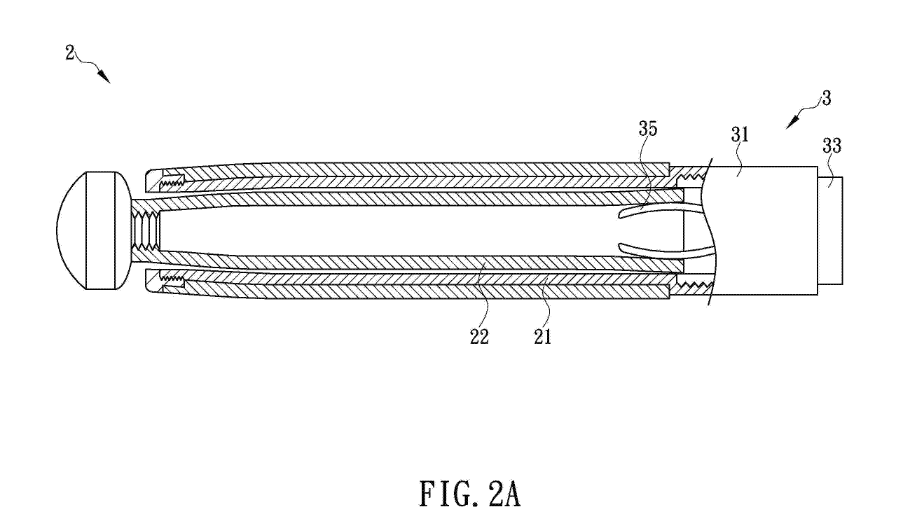

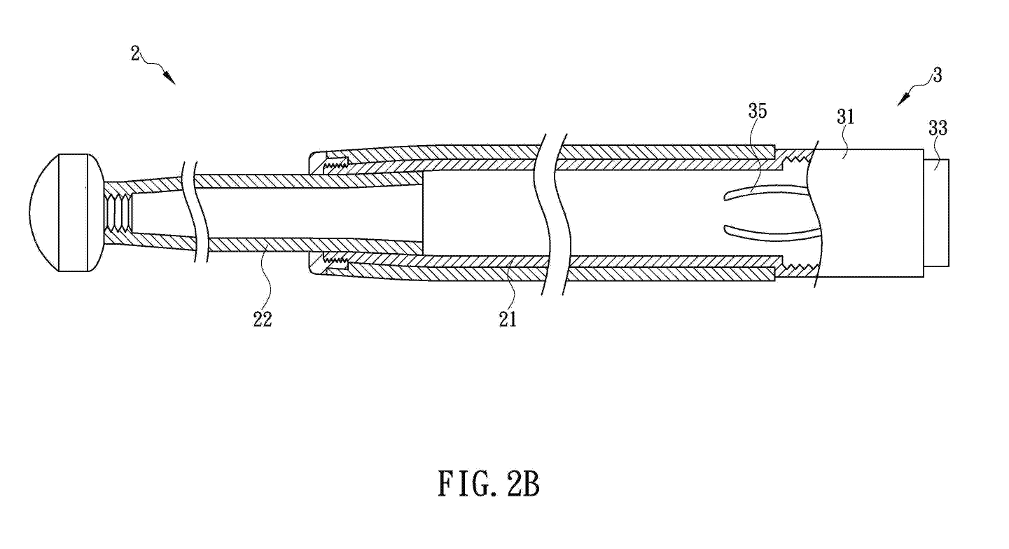

The present invention is directed to an expandable baton structure with a hidden smasher at the rear end of its handle and also to the hidden smasher itself. In the first embodiment, referring to FIGS. 2A and 2B, the expandable baton structure 2 includes an outer tube 21, at least one inner tube 22, and a hidden smasher 3. The outer tube 21 is telescopically connected with the inner tube 22 and has a rear section forming a handle to be gripped by a user. The outer diameter of the front end of the inner tube 22 is smaller than the inner diameter of the rear end of the outer tube 21 so that the tubes 21 and 22 can be assembled together by inserting the front end of the inner tube 22 into the outer tube 21 through the rear end of the outer tube 21. In addition, the configuration of the rear end of the inner tube 22 matches the configuration of a portion of the outer tube 21 that is adjacent to the front end of the outer tube 21. Therefore, when the expandable baton structure 2 is in an expanded state, meaning the inner tube 22 has been displaced outward toward the front end of the outer tube 21 such that the rear end of the inner tube 22 reaches a position in the outer tube 21 that is adjacent to the front end of the outer tube 21, the outer wall of the rear end of the inner tube 22 can engage with an inner wall portion of the outer tube 21 that is adjacent to the front end of the outer tube 21 (as shown in FIG. 2B), allowing a portion of the inner tube 22 that is adjacent to the rear end of the inner tube 22 to be secured in the outer tube 21 while the rest of the inner tube 22 is exposed from the front end of the outer tube 21.

It should be pointed out that when the expandable baton structure 2 is provided with a plurality of inner tubes 22, referring back to FIGS. 2A and 2B, the inner tubes 22 are sequentially connected in a telescopic manner so that, once the expandable baton structure 2 is expanded, the inner tubes 22 can engage with one another in the same way as described above with respect to the outer tube 21 and a single inner tube 22. The method by which the outer tube 21 and the at least one inner tube 22 engage with each other can be any one achievable by the structure of an existing expandable baton, provided that the at least one inner tube 22 can retract into the outer tube 21 to form a short stick and can also expand with respect to the outer tube 21 to form a long stick. In short, the present invention imposes no limitation on the engaging method of the outer tube 21 and the at least one inner tube 22.

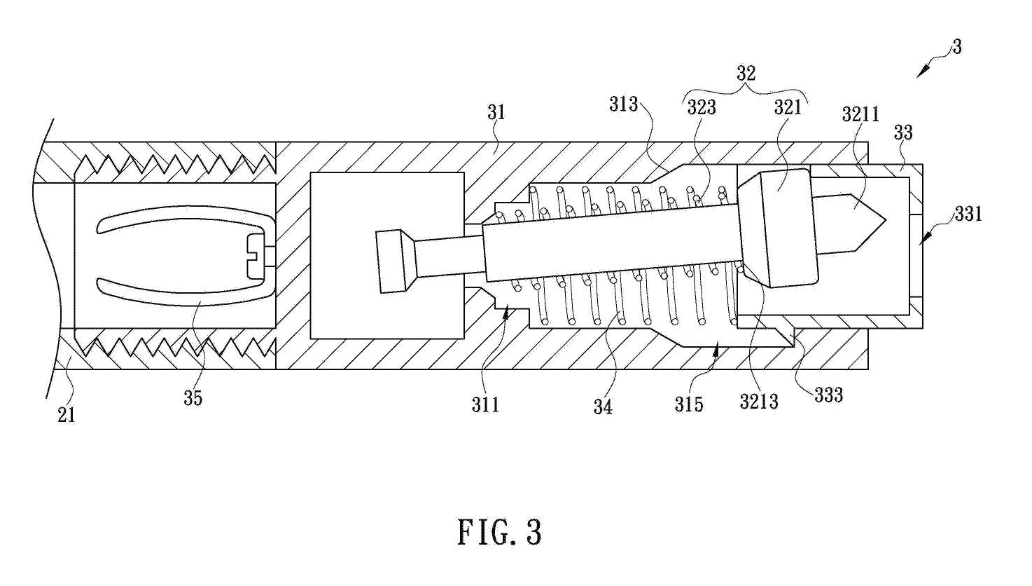

Referring to FIGS. 2A-3, the hidden smasher 3 is mounted at the rear end of the outer tube 21 (i.e., at the rear end of the handle) and is locked to the outer tube 21 threadedly by way of example. The hidden smasher 3 includes a base 31, a smashing portion 32, a protective cover 33, a restoring spring 34, and an engaging member 35. The front end of the base 31 has an external thread for locking with the thread at the rear end of the outer tube 21. The rear end of the base 31 is concavely provided with a storage space 311 for receiving the smashing portion 32. An aligning portion 313 is protrudingly provided in the base 31. The smashing portion 32 includes a smashing rod 321 and a compression spring 323. In the first embodiment, the rear end of the smashing rod 321 is provided with a smashing cone 3211, and the wall of the smashing rod 321 forms a shoulder 3213. The compression spring 323 is mounted around the front end of the smashing rod 321 and has its rear end pressed against the shoulder 3213 and its front end pressed against the inner wall of the base 31. The rear end of the protective cover 33 is formed with a through hole 331. The front end of the protective cover 33 extends into the rear end of the base 31 such that a portion of the protective cover 33 is pressed against a portion of the smashing rod 321 that is adjacent to the rear end of the smashing rod 321, thereby keeping the axis of the rear end of the smashing rod 321 offset from the axis of the through hole 331. In addition, the outer wall of the protective cover 33 is provided with a first sliding portion 333 (e.g., a protruding block), and the inner wall of the base 31 is provided with a second sliding portion 315 (e.g., a groove). The first sliding portion 333 is engaged in the second sliding portion 315, allowing the protective cover 33 to be axially displaced with respect to the base 31.

With continued reference to FIGS. 2A-3, the restoring spring 34 is located between the base 31 and the protective cover 33. The front end of the restoring spring 34 is pressed against the base 31 while the rear end of the restoring spring 34 is pressed against the protective cover 33. When the rear end of the protective cover 33 is not pressed against anything or subjected to a pressing force, the restoring spring 34 pushes the protective cover 33 away from the smashing portion 32 such that the protective cover 33 keeps the smashing cone 3211 hidden from view. When the rear end of the protective cover 33 is pressed against an object to be smashed (e.g., a glass window of a car) and then displaced toward the front end of the hidden smasher 3, the smashing rod 321 is pushed by the protective cover 33, or in other words pushed indirectly by the object to be smashed. The smashing rod 321 will be displaced in the base 31 toward the front end of the base 31 for a predetermined distance while compressing the compression spring 323 (which ends up substantially compressed and stores a large amount of elastic energy). In the meantime, the smashing rod 321 is aligned by the aligning portion 313 such that the axis of the rear end of the smashing rod 321 is gradually displaced to a position corresponding to the axis of the through hole 331. Once aligned, the smashing rod 321 is no longer pushed by the protective cover 33, and the elastic energy stored in the compression spring 323 will in turn push the smashing rod 321 directly and force the smashing rod 321 to strike toward the rear end of the base 31, in order for the smashing cone 3211 to penetrate the through hole 331 and smash the to-be-smashed object vigorously.

Referring again to FIGS. 2A-3, the engaging member 35 is provided at the front end of the base 31 and extends into the outer tube 21. When the inner tube 22 is stored in the outer tube 21 (as shown in FIG. 2A), the rear end of the inner tube 22 is secured by the engaging member 35 such that only the front end of the inner tube 22 is exposed from the front end of the outer tube 21. With the inner tube 22 securely positioned in the outer tube 21, the expandable baton structure 2 is in a short-stick configuration. When it is desired to use the expandable baton structure 2, the user only has to swing the expandable baton structure 2 forcibly so that the inner tube 22 is disengaged from the engaging member 35 by the swinging force, and the expandable baton structure 2 will be transformed into a long-stick configuration. The overall design of the hidden smasher 3 not only enables the outer tube 21 and the inner tube 22 to form a stable short-stick configuration, but also includes the protective cover 33 for storing and hiding the smashing cone 3211 automatically when the hidden smasher 3 is not in use, thus preventing the smashing cone 3211 from tearing or puncturing the user's clothes. Moreover, as the user does not have to remove the protective cover 33 when using the hidden smasher 3, the expandable baton structure 2 features great convenience of use, and the protective cover 33 will not get lost as may easily occur if the protective cover 33 were to be removed before use.

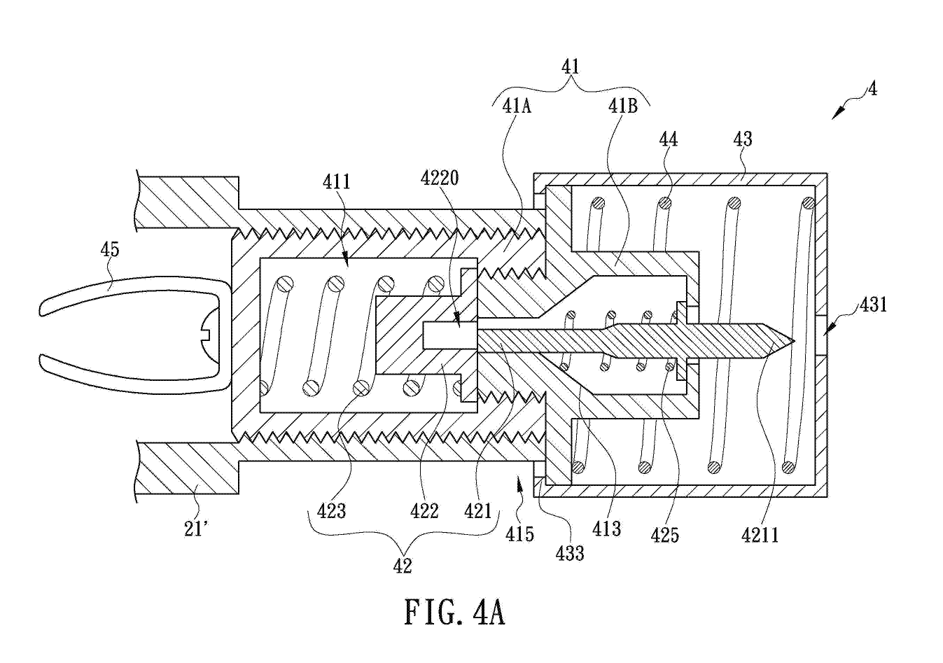

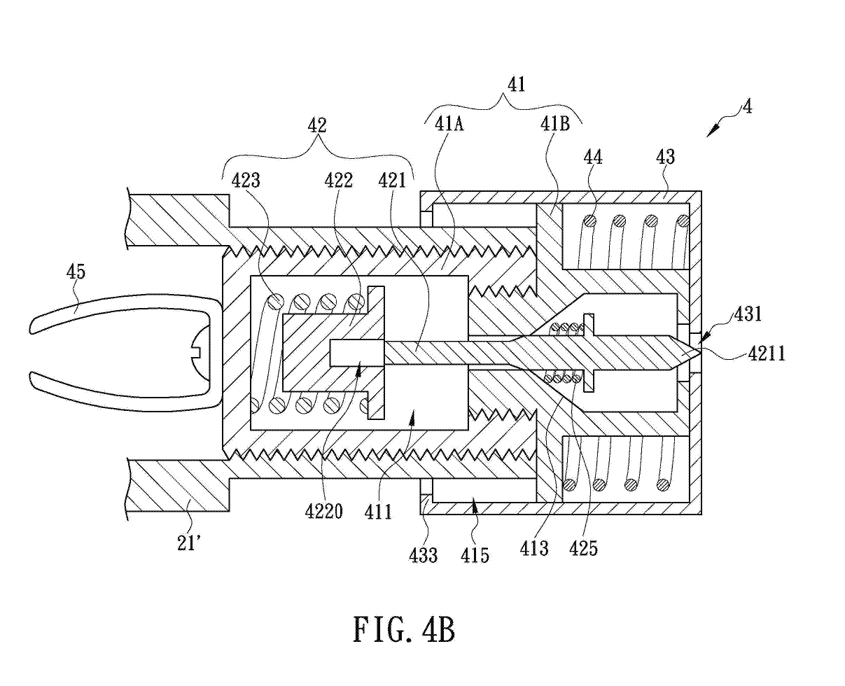

The structure of the hidden smasher may be modified to meet practical needs in use. Referring to FIGS. 4A and 4B for the second embodiment of the present invention for example, the hidden smasher 4 includes a base 41, a smashing portion 42, a protective cover 43, a restoring spring 44, and an engaging member 45. The base 41 is assembled from a first component 41A and a second component 41B, and the front end of the base 41 (i.e., the first component 41A) is provided with an external thread for locking with the thread at the rear end of the outer tube 21′. The engaging member 45 is provided at the front end of the base 41 (i.e., the front end of the first component 41A) and extends into the outer tube 21′ so that, once the inner tube is stored in the outer tube 21′, the rear end of the inner tube can be secured by the engaging member 45. Please note that the connection and assembly relationship between the outer tube 21′ and the inner tube is identical to that in the first embodiment and therefore will not be described repeatedly. The rear end of the base 41 (i.e., the rear end of the second component 41B) is concavely provided with a storage space 411. The storage space 411 corresponds to the interior of the first component 41A and the interior of the second component 41B. Also, an aligning portion 413 is protrudingly provided in the base 41. In the second embodiment, the aligning portion 413 is located in the second component 41B.

As shown in FIGS. 4A and 4B, the smashing portion 42 is located in the storage space 411 and includes a smashing rod 421, an impacting member 422, and a compression spring 423. The rear end of the smashing rod 421 is exposed from the rear end of the base 41 (i.e., the rear end of the second component 41B) and is provided with a smashing cone 4211. The rear end of the impacting member 422 is formed with an impact groove 4220, whose axis is offset from the axis of the front end of the smashing rod 421. When the smashing rod 421 is displaced toward the front end of the base 41 but not yet aligned by the aligning portion 413, the front end of the smashing rod 421 can be pressed against a portion of the impacting member 422 that is adjacent to the impact groove 4220 but will not extend into the impact groove 4220 (as shown in FIG. 4A). While the smashing rod 421 is being aligned by the aligning portion 413, the front end of the smashing rod 421 is gradually displaced to a position corresponding to the impact groove 4220 and eventually extends into the impact groove 4220 (as shown in FIG. 4B).

With continued reference to FIGS. 4A and 4B, the rear end of the protective cover 43 is formed with a through hole 431 corresponding in position to the smashing cone 4211. The front end of the protective cover 43 is mounted around the rear end of the base 41 (i.e., the rear end of the second component 41B). In addition, the inner wall of the protective cover 43 is provided with a first sliding portion 433 (e.g., a protruding block), and the outer wall of the base 41, with a second sliding portion 415 (e.g., a groove). The first sliding portion 433 is engaged in the second sliding portion 415, allowing the protective cover 43 to be axially displaced with respect to the base 41. The restoring spring 44 is located between the base 41 and the protective cover 43. The front end of the restoring spring 44 is pressed against the base 41 (i.e., the second component 41B) while the rear end of the restoring spring 44 is pressed against the protective cover 43. When the rear end of the protective cover 43 is not subjected to a pressing force, the restoring spring 44 pushes the protective cover 43 away from the smashing portion 42 such that the smashing cone 4211 is stored in the protective cover 43. When the rear end of the protective cover 43 is pressed against an object to be smashed (e.g., a glass window of a car) and then displaced toward the front end of the hidden smasher 4, the smashing cone 4211 is directly pushed by the to-be-smashed object through the through hole 431. As a result, the smashing rod 421 is displaced in the base 41 toward the front end of the base 41 for a predetermined distance and pushes the impacting member 422 at the same time, and the compression spring 423 is substantially compressed by the impacting member 422 and stores a large amount of elastic energy. During the process, the smashing rod 421 is also aligned by the aligning portion 413 such that the axis of the front end of the smashing rod 421 is gradually displaced to a position corresponding to the axis of the impact groove 4220. As soon as the two axes are in alignment, the front end of the smashing rod 421 extends into the impact groove 4220, and the elastic energy stored in the compression spring 423 pushes the impacting member 422 outward and forces the impacting member 422 (i.e., the bottom side of the impact groove 4220) to hit the front end of the smashing rod 421 in order for the smashing cone 4211 of the smashing rod 421 to smash the to-be-smashed object vigorously.

In the second embodiment, referring again to FIGS. 4A and 4B, an additional compression spring 425 may be mounted around the smashing rod 421 to increase the impact of the smashing rod 421, wherein the additional compression spring 425 has its rear end secured at the smashing rod 421 and its front end pressed against the inner wall of the base 41. When the smashing rod 421 is displaced rearward (i.e., toward the impacting member 422), it drives the impacting member 422 and compresses the additional compression spring 425 simultaneously. When the impacting member 422 subsequently pushes the smashing rod 421 forward (i.e., toward the to-be-smashed object), the additional compression spring 425 releases the elastic energy it stores, thus pushing the smashing rod 421 in conjunction with the compression spring 423 to increase the impact made by the smashing rod 421. Besides, the additional compression spring 425 helps keep the position of the smashing rod 421 to ensure that the smashing cone 4211 of the smashing rod 421 can extend out of the base 41.

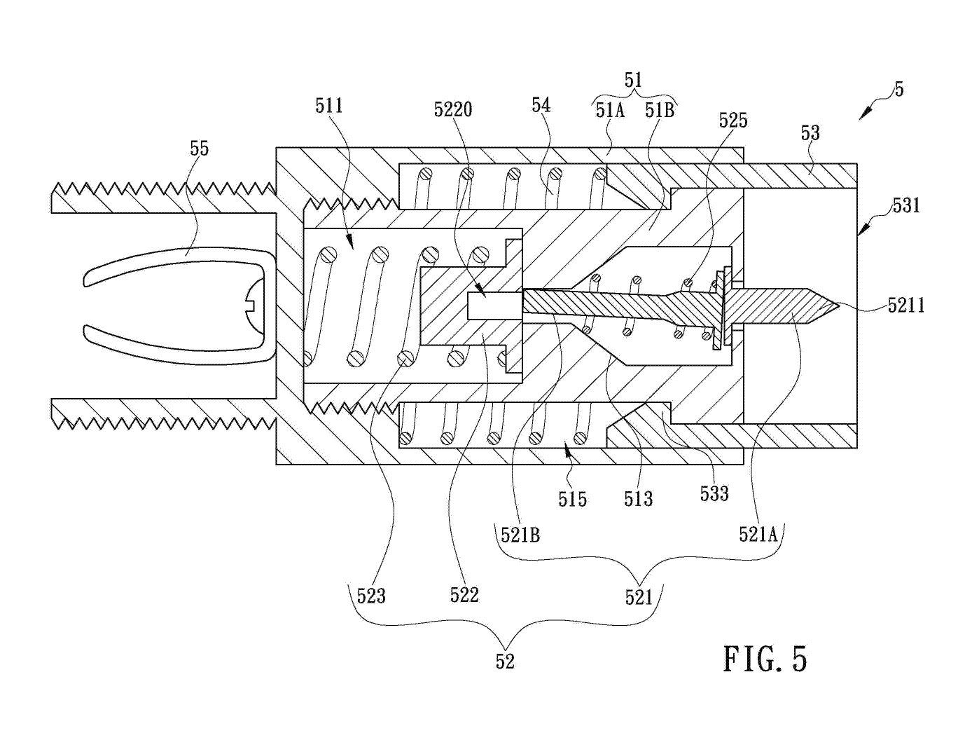

In the third embodiment, referring to FIG. 5, the hidden smasher 5 includes a base 51, a smashing portion 52, a protective cover 53, a restoring spring 54, and an engaging member 55. The base 51 is assembled from a first component 51A and a second component 51B, wherein the second component 51B is located in the first component 51A. The front end of the base 51 is provided with an external thread for locking with the thread at the rear end of the outer tube. The front end of the base 51 also has a recess, in which the engaging member 55 is provided. When the inner tube is stored in the outer tube, the rear end of the inner tube extends into the recess and is secured by the engaging member 55. The rear end of the base 51 (i.e., the rear end of the second component 51B) is concavely provided with a storage space 511. In the third embodiment, the storage space 511 corresponds to the interior of the second component 51B, and an aligning portion 513 is provided in the base 51.

As shown in FIG. 5, the smashing portion 52 is located in the storage space 511 and includes a smashing rod 521, an impacting member 522, and a compression spring 523. The assembly relationship and interaction between the components of the smashing portion 52 are the same as those of the smashing portion 42 in the second embodiment (as shown in FIGS. 4A and 4B), except that all the components of the smashing portion 52 in the third embodiment are located in the second component 51B whereas the components of the smashing portion 42 in the second embodiment are located partly in the first component 41A and partly in the second component 41B. For the sake of brevity, a detailed description of the assembly relationship and interaction between the components of the smashing portion 52 is omitted herein. In the third embodiment, the smashing rod 521 is composed of a first rod 521A and a second rod 521B to be pressed against the first rod 521A. The first rod 521A displaces the second rod 521B when pushed, and the second rod 521B thrusts the first rod 521A outward when impacted.

Referring again to FIG. 5, the rear end of the protective cover 53 is formed with a through hole 531 corresponding in position to the smashing cone 5211 (the smashing cone 5211 being provided on the first rod 521A). The front end of the protective cover 53 is fitted into the rear end of the base 51 (i.e., around the rear end of the second component 51B). In addition, the inner wall of the protective cover 53 is provided with a first sliding portion 533 (e.g., a protruding block), and the base 51 is provided therein (i.e., between the first component 51A and the second component 51B) with a second sliding portion 515 (e.g., a groove). The first sliding portion 533 is engaged in the second sliding portion 515, allowing the protective cover 53 to be axially displaced with respect to the base 51. The restoring spring 54 is located between the base 51 and the protective cover 53. The front end of the restoring spring 54 is pressed against the base 51 (i.e., the first component 51A) while the rear end of the restoring spring 54 is pressed against the protective cover 53. When the rear end of the protective cover 53 is not subjected to a pressing force, the restoring spring 54 pushes the protective cover 53 away from the smashing portion 52 such that the smashing cone 5211 is stored in the protective cover 53.

With continued reference to FIG. 5, when the rear end of the protective cover 53 is pressed against an object to be smashed (e.g., a glass window of a car) and then displaced toward the front end of the hidden smasher 5, the smashing cone 5211 is directly pushed by the to-be-smashed object through the through hole 531. As a result, the smashing rod 521 (i.e., the first rod 521A together with the second rod 521B pushed by the first rod 521A) and the impacting member 522 are displaced in the base 51 toward the front end of the base 51 for a predetermined distance, and the compression spring 523 is substantially compressed by the impacting member 522 and stores a large amount of elastic energy. During the process, the smashing rod 521 (i.e., the second rod 521B) is aligned by the aligning portion 513 such that the axis of the front end of the smashing rod 521 (i.e., the axis of the front end of the second rod 521B) is gradually displaced to a position corresponding to the axis of the impact groove 5220 of the impacting member 522. As soon as the two axes are in alignment, the elastic energy stored in the compressing spring 523 pushes the impacting member 522 outward and forces the impacting member 522 (i.e., the bottom side of the impact groove 5220) to hit the front end of the smashing rod 521 (i.e., the front end of the second rod 521B). The second rod 521B, in turn, pushes the first rod 521A in order for the smashing cone 5211 to smash the to-be-smashed object vigorously. In the third embodiment, it is equally feasible to mount an additional compression spring 525 around the second rod 521B to increase the overall impact of the smashing rod 521.

While the invention herein disclosed has been described by means of specific embodiments, numerous modifications and variations could be made thereto by those skilled in the art without departing from the scope of the invention set forth in the claims.

What is claimed is:

1. An expandable baton structure with a hidden smasher at a rear end of a handle, comprising:
an outer tube having a rear section forming the handle, wherein the handle is configured to be gripped by a user;
at least one inner tube having a front end with an outer diameter smaller than an inner diameter of a rear end of the outer tube to enable mounting the inner tube into the outer tube through the rear end of the outer tube, the inner tube further having a rear end in a configuration matching a configuration of a portion of the outer tube that is adjacent to a front end of the outer tube such that, when the inner tube is displaced outward toward the front end of the outer tube and brings the rear end of the inner tube to a position in the outer tube that is adjacent to the front end of the outer tube, the rear end of the inner tube is engageable with the portion of the outer tube that is adjacent to the front end of the outer tube, allowing a portion of the inner tube that is adjacent to the rear end of the inner tube to be secured in the outer tube while the remaining portion of the inner tube is exposed from the front end of the outer tube; and
the hidden smasher, mounted at the rear end of the outer tube and comprising:
a base having a front end secured at the rear end of the outer tube and a rear end concavely provided with a storage space, the base being further provided therein with an aligning portion;
a smashing portion located in the storage space of the base and comprising a smashing rod and a compression spring, wherein when pushed, the smashing rod simultaneously pushes the compression spring either directly or indirectly and is displaced in the base toward the front end of the base for a predetermined distance; and once the smashing rod is aligned by the aligning
portion, elastic energy stored in the compression spring pushes the smashing rod either directly or indirectly and forces the smashing rod to strike toward the rear end of the base;
a protective cover having a rear end formed with a through hole and a front end mounted at the rear end of the base, wherein the protective cover is axially displaceable with respect to the base;
a restoring spring located between the base and the protective cover such that, when the rear end of the protective cover is not pressed, the restoring spring pushes the protective cover away from the smashing portion, thereby keeping a smashing cone at a rear end of the smashing rod from exposure from the protective cover; when the rear end of the protective cover is pressed against a surface of a to-be-smashed object and then displaced toward a front end of the hidden smasher, the smashing rod is pushed either directly or indirectly by the to-be-smashed object and consequently displaced in the base toward the front end of the base for the predetermined distance; and once the smashing rod is aligned by the aligning portion, the elastic energy stored in the compression spring pushes the smashing rod either directly or indirectly and forces the smashing rod to strike toward the through hole of the protective cover, in order for the smashing cone of the smashing rod to smash the to-be-smashed object forcibly; and
an engaging member mounted at the front end of the base such that, when the inner tube is stored in the outer tube, the rear end of the inner tube is secured by the engaging member to render the expandable baton structure into a short-stick configuration.

2. The expandable baton structure of claim 1, wherein the protective cover is provided with a first sliding portion, the base is provided with a second sliding portion, and the first sliding portion is engaged in the second sliding portion, allowing the protective cover to be axially displaced with respect to the base.

3. The expandable baton structure of claim 2, wherein the smashing rod has a wall protrudingly provided with a shoulder; the compression spring is mounted around a front end of the smashing rod, has a rear end pressed against the shoulder, and has a front end pressed against an inner wall of the base; the front end of the protective cover extends into the base and has a portion pressed against a portion of the smashing rod that is adjacent to the rear end of the smashing rod such that an axis of the rear end of the smashing rod is offset from an axis of the through hole; when the rear end of the protective cover is pressed against the to-be-smashed object and displaced toward the front end of the hidden smasher, the smashing rod is pushed by the protective cover and consequently displaced in the base toward the front end of the base for the predetermined distance, during which time the smashing rod is aligned by the aligning portion such that the axis of the rear end of the smashing rod is gradually displaced to a position corresponding to the axis of the through hole; and once aligned, the smashing rod is no longer pushed by the protective cover, and the elastic energy stored in the compression spring pushes the smashing rod directly and forces the smashing cone of the smashing rod to smash the to-be-smashed object forcibly through the through hole.

4. The expandable baton structure of claim 2, wherein the smashing portion further comprises an impacting member; the impacting member has a rear end formed with an impact groove; the impact groove has an axis offset from an axis of a front end of the smashing rod; when the smashing rod is displaced toward the front end of the base but not yet aligned by the aligning portion, the front end of the smashing rod is able to be pressed against a portion of the impacting member that is adjacent to the impact groove, without extending into the impact groove; while the smashing rod is being aligned by the aligning portion, the front end of the smashing rod is gradually displaced to a position corresponding to the impact groove; and as soon as the smashing rod is aligned, the front end of the smashing rod extends into the impact groove such that the elastic energy stored in the compression spring pushes the impacting member outward and forces the impacting member to hit the front end of the smashing rod in order for the smashing cone of the smashing rod to smash the to-be-smashed object forcibly.

5. The expandable baton structure of claim 4, wherein the base is assembled from a first component and a second component, the first component has a front end mounted to the outer tube and a rear end secured to a front end of the second component, and the storage space corresponds to an interior of the first component and an interior of the second component.

6. The expandable baton structure of claim 4, wherein the base is assembled from a first component and a second component, the second component is located in the first component, the first component has a front end mounted to the outer tube, and the smashing portion is located in the second component.

7. A hidden smasher mounted at a rear end of a handle, wherein the hidden smasher is mounted at a rear end of an outer tube of an expandable baton, the outer tube has a rear section forming the handle, and the handle is configured to be gripped by a user, the hidden smasher comprising:
a base having a front end secured at the rear end of the outer tube and a rear end concavely provided with a storage space, the base being further provided therein with an aligning portion;
a smashing portion located in the storage space of the base and comprising a smashing rod and a compression spring, wherein when pushed, the smashing rod simultaneously pushes the compression spring either directly or indirectly and is displaced in the base toward the front end of the base for a predetermined distance;
and once the smashing rod is aligned by the aligning portion, elastic energy stored in the compression spring pushes the smashing rod either directly or indirectly and forces the smashing rod to strike toward the rear end of the base;
a protective cover having a rear end formed with a through hole and a front end mounted at the rear end of the base, wherein the protective cover is axially displaceable with respect to the base;
a restoring spring located between the base and the protective cover such that, when the rear end of the protective cover is not pressed, the restoring spring pushes the protective cover away from the smashing portion, thereby keeping a smashing cone at a rear end of the smashing rod from exposure from the protective cover; when the rear end of the protective cover is pressed against a surface of a to-be-smashed object and then displaced toward a front end of the hidden smasher, the smashing rod is pushed either directly or indirectly by the to-be-smashed object and consequently displaced in the base toward the front end of the base for the predetermined distance; and once the smashing rod is aligned by the aligning portion, the elastic energy stored in the compression spring pushes the smashing rod either directly or indirectly and forces the smashing rod to strike toward the through hole of the protective cover, in order for the smashing cone of the smashing rod to smash the to-be-smashed object forcibly; and
an engaging member mounted at the front end of the base such that, when the expandable baton is in a short-stick configuration, the engaging member secures an inner tube of the expandable baton.

8. The hidden smasher of claim 7, wherein the protective cover is provided with a first sliding portion, the base is provided with a second sliding portion, and the first sliding portion is engaged in the second sliding portion, allowing the protective cover to be axially displaced with respect to the base.

9. The hidden smasher of claim 8, wherein the smashing rod has a wall protrudingly provided with a shoulder; the compression spring is mounted around a front end of the smashing rod, has a rear end pressed against the shoulder, and has a front end pressed against an inner wall of the base; the front end of the protective cover extends into the base and has a portion pressed against a portion of the smashing rod that is adjacent to the rear end of the smashing rod such that an axis of the rear end of the smashing rod is offset from an axis of the through hole; when the rear end of the protective cover is pressed against the to-be-smashed object and displaced toward the front end of the hidden smasher, the smashing rod is pushed by the protective cover and consequently displaced in the base toward the front end of the base for the predetermined distance, during which time the smashing rod is aligned by the aligning portion such that the axis of the rear end of the smashing rod is gradually displaced to a position corresponding to the axis of the through hole; and once aligned, the smashing rod is no longer pushed by the protective cover, and the elastic energy stored in the compression spring pushes the smashing rod directly and forces the smashing cone of the smashing rod to smash the to-be-smashed object forcibly through the through hole.

10. The hidden smasher of claim 8, wherein the smashing portion further comprises an impacting member; the impacting member has a rear end formed with an impact groove; the impact groove has an axis offset from an axis of a front end of the smashing rod; when the smashing rod is displaced toward the front end of the base but not yet aligned by the aligning portion, the front end of the smashing rod is able to be pressed against a portion of the impacting member that is adjacent to the impact groove, without extending into the impact groove; while the smashing rod is being aligned by the aligning portion, the front end of the smashing rod is gradually displaced to a position corresponding to the impact groove; and as soon as the smashing rod is aligned, the front end of the smashing rod extends into the impact groove such that the elastic energy stored in the compression spring pushes the impacting member outward and forces the impacting member to hit the front end of the smashing rod in order for the smashing cone of the smashing rod to smash the to-be-smashed object forcibly.

11. The hidden smasher of claim 10, wherein the base is assembled from a first component and a second component, the first component has a front end mounted to the outer tube and a rear end secured to a front end of the second component, and the storage space corresponds to an interior of the first component and an interior of the second component.

12. The hidden smasher of claim 10, wherein the base is assembled from a first component and a second component, the second component is located in the first component, the first component has a front end mounted to the outer tube, and the smashing portion is located in the second component.
